(19) United States
(12) Patent Application Publication
(10) Pub. No.: US 2025/0036969 A1
(43) Pub. Date: Jan. 30, 2025

(54) MULTILINGUAL EVENT CAUSALITY IDENTIFICATION METHOD AND SYSTEM BASED ON META-LEARNING WITH KNOWLEDGE

(71) Applicant: National University of Defense Technology, Changsha (CN)

(72) Inventors: Fei CAI, Changsha (CN); Shen WANG, Changsha (CN); Mengxi ZHANG, Changsha (CN)

(73) Assignee: National University of Defense Technology, Changsha (CN)

(21) Appl. No.: 18/791,863

(22) Filed: Aug. 1, 2024

(30) Foreign Application Priority Data
Apr. 15, 2024 (CN) 202410446413.6

(51) Int. Cl. G06N 5/01; G06N 5/022

(52) U.S. Cl. CPC G06N 5/01; G06N 5/022

(57) ABSTRACT

Disclosed are a multilingual event causality identification method and a multilingual event causality identification system based on meta-learning with knowledge. The method includes: partitioning a to-be-processed multilingual dataset into a plurality of sub-datasets; tagging target events corresponding to all data samples in the sub-datasets; obtaining background knowledge for the various events of different language types and combining the background knowledge with a corresponding data sample; basic input samples of all non-target languages in the basic input sample constituting a plurality of basic datasets, and all the remaining basic input samples constituting a target dataset; partitioning support sets and query sets; constructing a multilingual causal identifier; training the multilingual causal identifier based on the support sets and query sets in the plurality of basic datasets to obtain an optimal hyper-parameter; and training the multilingual causal identifier by using the support set in the target dataset, to obtain an optimal non-hyper-parameter.

### CROSS-REFERENCE TO RELATED APPLICATIONS

The application claims priority to Chinese Patent Application CN202410446413.6, filed on Apr. 15, 2024, which is incorporated herein by reference in its entirety.

### TECHNICAL FIELD

The present disclosure belongs to the field of information extraction, and in particular to a multilingual event causality identification method and a multilingual event causality identification system based on meta-learning with knowledge.

### BACKGROUND

Multilingual event causality identification (multilingual ECI for short) is a task for detecting the causality between events in a multilingual text. As an important task in the field of information extraction, event causality identification aims at determining whether or not the causality exists between the events in the text, and can support a plurality of downstream applications such as machine reading comprehension, knowledge graph construction, and intelligent question answering for predicting future events. Currently, most existing research concentrates on solving ECI tasks in an English corpus, including a feature-based method, a traditional neural network method, a pre-trained language model, and a prompt-based learning method. Although these methods can solve the ECI tasks in an English environment to some extent, they have poor performances in other language environments, especially in a multilingual environment with fewer resources, that is, the existing mature ECI model cannot achieve across-language generalization, causing that the existing technology identifies the event causality inaccurately in the multilingual environment with fewer resources.

### SUMMARY

The present disclosure provides a multilingual event causality identification method and a multilingual event causality identification system based on meta-learning with knowledge, to solve the issue of poor identification performance in a multilingual environment with fewer resources.

In the first aspect, the present disclosure provides a multilingual event causality identification method based on meta-learning with knowledge, and the method includes the following steps:
partitioning a to-be-processed multilingual dataset into a plurality of sub-datasets according to language types;
tagging target events corresponding to all data samples in the plurality of sub-datasets;
obtaining background knowledge for the various target events of different language types by using a preset semantic network and a knowledge reasoning framework, and combining the background knowledge with a corresponding data sample to obtain a basic input sample;
basic input samples of all non-target languages in the basic input sample constituting a plurality of basic datasets according to the language types, and all the remaining basic input samples constituting a target dataset;
partitioning both the target dataset and the plurality of basic datasets into support sets and query sets;
constructing a multilingual causal identifier based on a multilingual pre-trained model;
training the multilingual causal identifier based on the support sets and query sets in the plurality of basic datasets and using a prototype network and a hybrid meta-learning strategy with an unknown model, to obtain an optimal hyper-parameter of the multilingual causal identifier;
training the multilingual causal identifier by using the support set in the target dataset, to obtain an optimal non-hyper-parameter of the multilingual causal identifier; and
identifying the causality between events corresponding to all samples in the query set of the target dataset through the multilingual causal identifier.

Optionally, the obtaining the background knowledge for the various target events of different language types by using the preset semantic network and the knowledge reasoning framework, and combining the background knowledge with the corresponding data sample to obtain the basic input sample includes the following steps:
traversing all data samples, searching by using the preset semantic network to obtain target background knowledge of the target events corresponding to the data samples;
denoting the data samples that do not obtain the target background knowledge by searching the semantic network as special data samples;
constructing a knowledge reasoning model based on the preset knowledge reasoning framework and combining it with a language translator;
inputting the special data samples to the knowledge reasoning model, to obtain an initial knowledge network;
generating a target knowledge network by combining the initial knowledge network with the target background knowledge; and
textualizing the target knowledge network and combining the target knowledge network with the data samples, to obtain the basic input samples.

Optionally, the constructing the multilingual causal identifier based on the multilingual pre-trained model includes the following steps:
constructing a basic learner based on the multilingual pre-trained model, and the basic learner including an initial hyper-parameter that needs to be learned;
overlaying a linear layer on the basic learner, and the linear layer including a bias parameter and a weight coefficient; and
nesting the basic learner overlapped with the linear layer into a nonlinear activation layer, to constitute the multilingual causal identifier.

Optionally, the training the multilingual causal identifier based on the support sets and query sets in the plurality of basic datasets and using the prototype network and the hybrid meta-learning strategy with the unknown model to obtain the optimal hyper-parameter of the multilingual causal identifier includes the following steps:
coding all target basic input samples in the support sets of the basic datasets by using the basic learner, and obtaining a sample prototype of each target basic input sample by calculating an average value of template coding with the corresponding type of the target basic input samples;
performing normalization processing on all sample prototypes based on an L2 standardization strategy;
defining the bias parameter and weight coefficient according to the sample prototypes, to complete an approximate calculation for the bias parameter and weight coefficient;
performing a causal prediction on the query set in the basic dataset through the multilingual causal identifier, calculating and obtaining a causal prediction error according to a prediction result of the causal prediction;
performing iterative training on the multilingual causal identifier based on the meta-learning strategy with an unknown model with a target of minimizing the causal prediction error, and obtaining the optimal hyper-parameter of the multilingual causal identifier.

Optionally, the optimal hyper-parameter has an expression formula as follows:

$${Θ}^{*} := \begin{matrix}arg max \\ Θ\end{matrix} {𝔼}_{k ⊂ K} [ {𝔼}_{{\tilde{S}}_{l} ⊂ {\tilde{D}}_{l} , {\tilde{Q}}_{l} ⊂ {\tilde{D}}_{l}} [ {\sum }_{( {\tilde{d}}^{l} , y ) ∈ {\tilde{Q}}_{l}} {P}_{Θ} ( y \vert {\tilde{d}}^{l} , {\tilde{S}}_{l} ) ] ]$$

in the formula, Θ represents an initial hyper-parameter, Θ* represents an optimal hyper-parameter, :=represents a defined symbol, K represents total rounds in the iterative training, k represents the k-th optimal iterative process in the iterative training, [symbol] _{k⊂K} represents an expectation for the k-th optimal iterative process, [symbol] _{\tilde{S}S}_{ₗ}_{⊂\tilde{D}}_{ₗ}_{,\tilde{Q}}_{ₗ}_{⊂\tilde{D}}_{ₗ} represents an expectation under the training of the support set and query set in the basic dataset, \tilde{D}ₗ={\tilde{S}ₗ, \tilde{Q}ₗ}, \tilde{D}ₗ represent a basic dataset, \tilde{S}ₗ represents a support set of the basic dataset, \tilde{Q}ₗ represents a query set of the basic dataset, \tilde{d}^{l} represents a basic input sample, y represents a tag corresponding to the basic input sample, and P_{Θ}(y|\tilde{d}^{l}, \tilde{S}ₗ) represents a conditional probability.

In a second aspect, the present disclosure provides a multilingual event causality identification system based on meta-learning with knowledge, and the system includes:
a dataset classification module, configured to partition a to-be-processed multilingual dataset into a plurality of sub-datasets according to language types;
an event tagging module, configured to tag target events corresponding to all data samples in the plurality of sub-datasets;
a sample composition module, configured to obtain background knowledge for the various target events of different language types by using a preset semantic network and a knowledge reasoning framework, and to combine the background knowledge with a corresponding data sample to obtain a basic input sample;
a dataset composition module, configured to enable the basic input samples of all non-target languages in the basic input sample to constitute a plurality of basic datasets according to the language types, and to enable all the remaining basic input samples to constitute a target dataset;
a dataset partitioning module, configured to partition both the target dataset and the plurality of basic datasets into support sets and query sets;
an identifier composition module, configured to construct a multilingual causal identifier based on a multilingual pre-trained model;
a first identifier training module, configured to train the multilingual causal identifier based on the support sets and query sets in the plurality of basic datasets and using a prototype network and a hybrid meta-learning strategy with an unknown model, to obtain an optimal hyper-parameter of the multilingual causal identifier;
a second identifier training module, configured to train the multilingual causal identifier by using the support set in the target dataset, to obtain an optimal non-hyper-parameter of the multilingual causal identifier; and
a causality identification module, configured to identify the causality between events corresponding to all samples in the query set of the target dataset through the multilingual causal identifier.

Optionally, the sample composition module includes:
a knowledge searching unit, configured to traverse all data samples, to search by using the preset semantic network to obtain target background knowledge of the target events corresponding to the data samples;
a sample tagging unit, configured to denote the data samples that do not obtain the target background knowledge by searching the semantic network as special data samples;
a reasoning model construction unit, configured to construct a knowledge reasoning model based on the preset knowledge reasoning framework and combined with a language translator;
a first knowledge network generation unit, configured to input the special data samples to the knowledge reasoning model, to obtain an initial knowledge network;
a second knowledge network generation unit, configured to generate a target knowledge network by combining the initial knowledge network with the target background knowledge; and
a sample generation unit, configured to textualize the target knowledge network and combine the target knowledge network with the data samples, to obtain the basic input samples.

Optionally, the identifier composition module includes:
a learner construction unit, configured to construct a basic learner based on the multilingual pre-trained model, where the basic learner includes an initial hyper-parameter that needs to be learned;
a linear layer overlapping unit, configured to overlay a linear layer on the basic learner, where the linear layer includes a bias parameter and a weight coefficient;
an identifier construction unit, configured to nest the basic learner overlapped with the linear layer into a nonlinear activation layer, to constitute the multilingual causal identifier.

Optionally, the first identifier training module includes:
a prototype calculation unit, configured to code all target basic input samples in the support sets of the basic datasets by using the basic learner, and to obtain a sample prototype of each target basic input sample by calculating an average value of template coding with the corresponding type of the target basic input samples;
a standardized processing unit, configured to perform normalization processing on all sample prototypes based on a L2 standardization strategy;
a parameter calculation unit, configured to define the bias parameter and weight coefficient according to the sample prototypes, to complete an approximate calculation for the bias parameter and weight coefficient;
an error calculation unit, configured to perform a causal prediction on the query set in the basic dataset through the multilingual causal identifier, and to calculate and obtain a causal prediction error according to a prediction result of the causal prediction; and
an iterative training unit, configured to perform iterative training on the multilingual causal identifier based on the meta-learning strategy with an unknown model with a target of minimizing the causal prediction error, and to obtain the optimal hyper-parameter of the multilingual causal identifier.

Optionally, the optimal hyper-parameter has an expression formula as follows:

$${Θ}^{*} := \begin{matrix}arg max \\ Θ\end{matrix} {𝔼}_{k ⊂ K} [ {𝔼}_{{\tilde{S}}_{l} ⊂ {\tilde{D}}_{l} , {\tilde{Q}}_{l} ⊂ {\tilde{D}}_{l}} [ {\sum }_{( {\tilde{d}}^{l} , y ) ∈ {\tilde{Q}}_{l}} {P}_{Θ} ( y \vert {\tilde{d}}^{l} , {\tilde{S}}_{l} ) ] ]$$

in the formula, Θ represents an initial hyper-parameter, Θ* represents an optimal hyper-parameter, :=represents a defined symbol, K represents total rounds in the iterative training, k represents the k-th optimal iterative process in the iterative training, [symbol] _{k⊂K} represents an expectation for the k-th optimal iterative process, [symbol] _{\tilde{S}S}_{ₗ}_{⊂\tilde{D}}_{ₗ}_{,\tilde{Q}}_{ₗ}_{⊂\tilde{D}}_{ₗ} represents an expectation under the training of the support set and query set in the basic dataset, \tilde{D}ₗ={\tilde{S}ₗ, \tilde{Q}ₗ}, \tilde{D}ₗ represent a basic dataset, \tilde{S}ₗ represents a support set of the basic dataset, \tilde{Q}ₗ represents a query set of the basic dataset, \tilde{d}^{l} represents a basic input sample, y represents a tag corresponding to the basic input sample, and P_{Θ}(y|\tilde{d}^{l}, \tilde{S}ₗ) represents a conditional probability.

The present disclosure has the following beneficial effects.

The background knowledge is obtained for the various multilingual events by using the preset semantic network and the knowledge reasoning framework, and based on the existing multilingual knowledge base, the background knowledge directly associated with the task is generated, thereby achieving the alleviation of data scarcity by introducing external multilingual knowledge. To catch the causal cue in different language texts, the mode of constructing the multilingual causal identifier based on the multilingual pre-trained model and iteratively training the constructed causal identifier through the prototype network and the hybrid meta-learning strategy with the unknown model can extract generalized causal knowledge from the language texts, thus solving the problem of identifying the event causality in low-resource languages.

### BRIEF DESCRIPTION OF THE DRAWINGS

FIG. 1 is a process diagram of a multilingual event causality identification method based on meta-learning with knowledge in one implementation mode of this application.

FIG. 2 is a flow process diagram of a multilingual event causality identification method based on meta-learning with knowledge in one implementation mode of this application.

FIG. 3 is a schematic structural diagram of a multilingual event causality identification system based on meta-learning with knowledge in this application.

FIG. 4 is a schematic structural diagram of a sample structural module in this application.

FIG. 5 is a schematic structural diagram of an identifier composition module in this application.

FIG. 6 is a schematic structural diagram of an identifier training module in this application.

### DETAILED DESCRIPTION OF THE EMBODIMENTS

The following clearly describes the technical solutions in the embodiments of this application concerning the accompanying drawings in the embodiments of this application. The described embodiments are some rather than all of the embodiments of this application. Based on the embodiments of this application, all the other embodiments obtained by those of ordinary skill in the art should belong to the protection scope of this application.

Terms “first” and “second” in the description and claims of this application are used to distinguish between similar objects, and not used to describe a specific order or sequence. It should be understood that the data termed in such a way is interchangeable in proper circumstances so that the embodiments of this application can be implemented in an order other than the order illustrated or described herein. Moreover, the object distinguished by “first”, “second” and the like is usually the same class, the number of the object is not defined, for example, the first object may be one or multiple. In addition, “and/or” used in the description and claims means at least one of the connected objects, and the character “/” usually means that a contextual correlation object is a “or” relation.

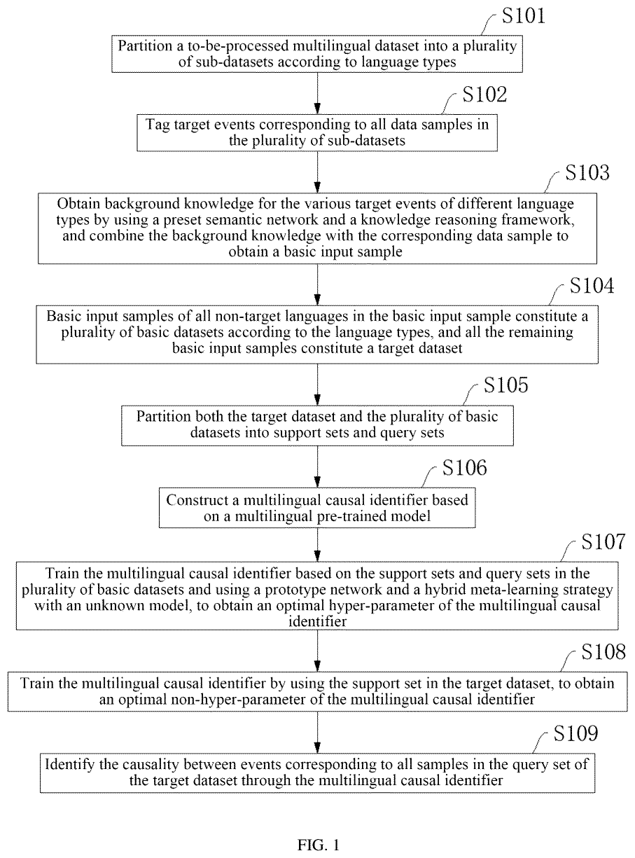

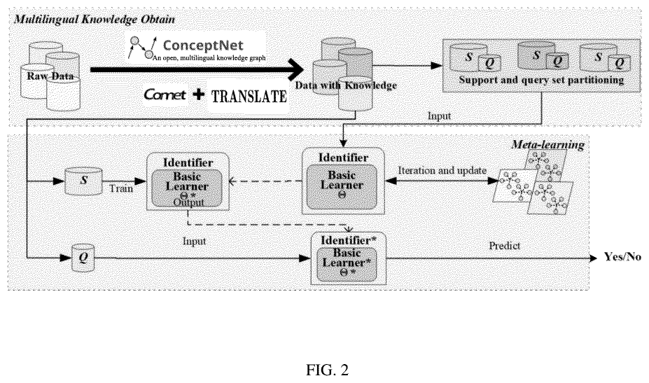

FIG. 1 is a process diagram of a multilingual event causality identification method based on meta-learning with knowledge in one embodiment. It should be understood that, although various steps in the flowcharts of FIG. 1 are successively displayed according to the indication of an arrow, those steps are not necessarily implemented according to the order indicated by the arrow. Unless otherwise specified herein, the implementation of those steps is not strictly limited by the order, and those steps may be implemented in other orders. Moreover, at least partial steps in FIG. 1 may include a plurality of sub-steps or a plurality of stages, these sub-steps or stages are not necessarily implemented or completed at the same time, and may be implemented at different times. The implementation order of these sub-steps or stages is not necessarily performed successively, but implemented in turns or alternately with other steps or the sub-steps or stages of other steps. As shown in FIG. 2, the present disclosure provides a multilingual event causality identification method based on meta-learning with knowledge, including the following steps:
S101: partitioning a to-be-processed multilingual dataset into a plurality of sub-datasets according to language types.

The purpose of this step is to separate the dataset including a plurality of languages into separate language sub-datasets. A language identifier, such as fastText or LangID can be used to identify the language of each data sample automatically, and then classification is performed accordingly.

S102: tagging target events corresponding to all data samples in the plurality of sub-datasets.

The data sample in each sub-dataset is subjected to event tagging, and the tagged event serves as a target event. The use of natural language processing (NLP) technology can be involved to identify event entities and attributes thereof in the text. The event tagging can be completed manually, or an automatic event extraction algorithm can be used.

S103: obtaining background knowledge for the various target events of different language types by using a preset semantic network and a knowledge reasoning framework, and combining the background knowledge with a corresponding data sample to obtain a basic input sample.

The related background knowledge is obtained for each event by using the present semantic network (WordNet or ConceptNet) and the knowledge reasoning framework (e.g., a knowledge graph reasoning engine). The background knowledge can help the model understand the context and meaning of the event better. The knowledge is combined with the data samples, to form the basic input samples.

S104: basic input samples of all non-target languages in the basic input sample constituting a plurality of basic datasets according to the language types, and all the remaining basic input samples constituting a target dataset.

S105: partitioning both the target dataset and the plurality of basic datasets into support sets and query sets.

Both the basic datasets and the target datasets are further divided into two parts, the support sets are used for model training, and the query sets are used for testing the generalization ability of the model. In the framework, a group of support sets and query sets are all from the same language, but include different samples.

S106: constructing a multilingual causal identifier based on a multilingual pre-trained model.

The multilingual pre-trained model (such as mBERT or XLM-R) serves as the basic learner in the multilingual causal identifier. These models have been pre-trained on a mass of multilingual data, thus enabling them to have better language comprehension abilities.

S107: training the multilingual causal identifier based on the support sets and query sets in the plurality of basic datasets and using a prototype network and a hybrid meta-learning strategy with an unknown model, to obtain an optimal hyper-parameter of the multilingual causal identifier.

The embedded representation of the samples in the support sets of the basic datasets is learned based on the basic learner in the multilingual causal identifier, the prototype network is constructed based on the embedded representation, and the prototype is calculated, then the bias parameter and the weight coefficient of the linear layer of the causal identifier are obtained based on the prototype calculation, and finally, the multilingual causal identifier is trained in combination with the meta-learning strategy with the unknown model and with the target of minimizing the causal prediction error of the multilingual causal identifier in the samples of the query sets in the basic dataset. The prototype network is used to calculate representative features (prototype) of different causal forms under the same language, and however the meta-learning strategy with the unknown model is used to allow the causal identifier to learn language-independent causal knowledge, thus quickening the adaptation for new tasks.

S108: training the multilingual causal identifier by using the support set in the target dataset, to obtain an optimal non-hyper-parameter of the multilingual causal identifier.

The multilingual causal identifier with the optimal hyper-parameter is further trained by using the support set in the target dataset, to obtain the optimal non-hyper-parameter, suitable for the event causality identification task under the target language, in the multilingual causal identifier.

S109: identifying the causality between events corresponding to all samples in the query set of the target dataset through the multilingual causal identifier.

The causality between the events in the multilingual data sample is identified by using the multilingual causal identifier with the optimal hyper-parameter and the optimal non-hyper-parameter. This may involve in the use of the causal reasoning algorithm to analyze the timing sequence and logical relation between the events, and the use of the knowledge learned from the model to infer the possible causal chain.

In one implementation mode, the step S303 specifically includes the following steps:
traversing all data samples, searching by using the preset semantic network to obtain target background knowledge of the target events corresponding to the data samples;
denoting the data samples that do not obtain the target background knowledge by searching the semantic network as special data samples;
constructing a knowledge reasoning model based on the preset knowledge reasoning framework and combining it with a language translator;
inputting the special data samples to the knowledge reasoning model, to obtain an initial knowledge network;
generating a target knowledge network by combining the initial knowledge network with the target background knowledge; and
textualizing the target knowledge network and combining the target knowledge network with the data samples, to obtain the basic input samples.

In this implementation mode, referring to FIG. 2, all data samples are traversed, and the preset semantic network (e.g., WordNet, ConceptNet) is used to search the background knowledge associated with the event in each data sample of different languages. The semantic network usually includes a lot of concepts and entities as well as the relation therebetween, thus providing the detailed information and context of the related event. If the related background knowledge of some data samples cannot be directly obtained through the semantic network, these samples shall be denoted as special data samples. This may be that they contain rare events, proper nouns, or new words, which are not in the coverage of the semantic network.

The preset knowledge reasoning framework usually adopts COMET, which is a pre-trained knowledge generation method to complete the knowledge graph, and however the basic COMET only supports the completion of the Conceptnet English edition currently. Therefore, the existing COMET needs to be improved to mCOMET, that is, the knowledge reasoning model capable of processing multilingual input is constructed in combination with the language translator. This model aims at inferring and generating the background knowledge that is not directly covered by the semantic network. The special data samples are input to the knowledge reasoning model, and an initial knowledge network is generated by using the reasoning ability of the model. Thus, a certain non-English event is translated into an event in an English context, then this event is input into COMET together with the known relation, to generate corresponding English knowledge nodes, and then the English knowledge nodes are translated back into the original language again by the Baidu translator.

A more complete target knowledge network is generated in combination with the target background knowledge and the initial knowledge network that is searched from the semantic network. This network combines with the knowledge that is obtained through direct searching and reasoning, thus providing more complete background information to the data samples. The target knowledge network is converted to a text form and combined with the original data sample. The finally obtained basic input sample will contain rich background knowledge, laying a foundation for event identification and causality under the multilingual context.

In one implementation mode, the step S106 includes the following steps:
constructing a basic learner based on the multilingual pre-trained model, and the basic learner including an initial hyper-parameter that needs to be learned;
overlaying a linear layer on the basic learner, and the linear layer including a bias parameter and a weight coefficient; and
nesting the basic learner overlapped with the linear layer into a nonlinear activation layer, to constitute the multilingual causal identifier.

In this implementation mode, the basic learner is a deep learning model with the purpose of learning the event text embedded representation capable of including the causal cue better from the data. The basic learner is constructed based on the multilingual pre-trained model, such as mBERT, GPT, and XLM-R, and these models have been pre-trained in a mass of multilingual texts, to learn the universal representation of the language. As the basic learner, the pre-trained model contains rich language features and contextual information.

In one implementation mode, the step S107 includes the following steps:
coding all target basic input samples in the support sets of the basic datasets by using the basic learner, and obtaining a sample prototype of each target basic input sample by calculating an average value of template coding with the corresponding type of the target basic input samples;
performing normalization processing on all sample prototypes based on an L2 standardization strategy;
defining the bias parameter and weight coefficient according to the sample prototypes, to complete an approximate calculation for the bias parameter and weight coefficient;
performing a causal prediction on the query set in the basic dataset through the multilingual causal identifier, calculating and obtaining a causal prediction error according to a prediction result of the causal prediction;
performing iterative training on the multilingual causal identifier based on the meta-learning strategy with an unknown model with a target of minimizing the causal prediction error, and obtaining the optimal hyper-parameter of the multilingual causal identifier.

In this implementation mode, the support set in the basic dataset contains a series of samples that have been tagged with the events and causality thereof. The basic learner in the causal identifier uses these samples for training, to adjust the model parameter, making the model capable of generating the accurate event text embedding. The event text embedding refers to the conversion of the text description of the event into vectors in a numerical value form, and these vectors can catch the semantics and contextual information of the event. The query set in the basic dataset includes a series of samples for testing the model, and these samples do not appear in the corresponding support set. The causal identification unit in the causal identifier predicts the causality between the events in the query set by using the event text embedding, obtained through basic learner coding and learning, in the query set; and a prediction result is compared with an actual causality, thus calculating the causal prediction error. The causal prediction error is the difference between the model prediction result and the real result and is usually measured by using a loss function (e.g., cross-entropy loss, or focal loss). To minimize the causal prediction error, the parameter of the causal identifier needs to be optimized through iterative training. This usually involves in the use of gradient descent or a variation thereof (e.g., an Adam optimizer) to update the model parameter. On each iteration, the model parameter will be adjusted according to the gradient of the loss function, to reduce the prediction error. The iterative training lasts until the performance of the model is not improved anymore or the preset stopping conditions are reached, and at this time the obtained parameter is regarded as the optimal parameter. Specifically, the optimal hyper-parameter has an expression formula as follows:

$${Θ}^{*} := \begin{matrix}arg max \\ Θ\end{matrix} {𝔼}_{k ⊂ K} [ {𝔼}_{{\tilde{S}}_{l} ⊂ {\tilde{D}}_{l} , {\tilde{Q}}_{l} ⊂ {\tilde{D}}_{l}} [ {\sum }_{( {\tilde{d}}^{l} , y ) ∈ {\tilde{Q}}_{l}} {P}_{Θ} ( y \vert {\tilde{d}}^{l} , {\tilde{S}}_{l} ) ] ]$$

in the formula, Θ represents an initial hyper-parameter, Θ* represents an optimal hyper-parameter, :=represents a defined symbol, K represents total rounds in the iterative training, k represents the k-th optimal iterative process in the iterative training, [symbol] _{k⊂K} represents an expectation for the k-th optimal iterative process, [symbol] _{\tilde{S}S}_{ₗ}_{⊂\tilde{D}}_{ₗ}_{,\tilde{Q}}_{ₗ}_{⊂\tilde{D}}_{ₗ} represents an expectation under the training of the support set and query set in the basic dataset, \tilde{D}ₗ={\tilde{S}ₗ, \tilde{Q}ₗ}, \tilde{D}ₗ represent a basic dataset, \tilde{S}ₗ represents a support set of the basic dataset, \tilde{Q}ₗ represents a query set of the basic dataset, \tilde{d}^{l} represents a basic input sample, y represents a tag corresponding to the basic input sample, and P_{Θ}(y|\tilde{d}^{l}, \tilde{S}ₗ) represents a conditional probability.

The sample prototype specifically refers to a central point represented by all samples of a certain type. The basic learner in the multilingual causal identifier codes all basic input samples in the support set of the basic dataset into embedding vectors. Then, for each causality tag type, an average value for embedding all samples under this type is calculated, to obtain the sample prototype of this type. This process may be understood as finding a representative central point in an embedding space, to reflect the common characteristic of all samples of this type. To eliminate the scale difference between different prototypes, normalization processing is performed on all sample prototypes based on an L2 standardization strategy. L2 standardization means dividing each prototype vector by a L2 norm thereof (i.e., a Euclid length of the vector), such that the length of each normalized prototype vector is 1. This helps improve the stability and generalization ability of the model.

The meta-learning strategy with the unknown model refers to a target of finding the optimal hyper-parameter of the multilingual causal identifier, a plurality of basic datasets are used to train and optimize the multilingual causal identifier continuously, that is, the training strategy continuously updates and iterates the basic learner, then the sample prototype is updated and calculated, the bias parameter and the weight coefficient of the linear layer of the multilingual causal identifier may also be defined based on the sample prototype and continuously updated and iterated, and finally the non-linear and linear activation layers of the multilingual causal identifier can perform the event causality identification by using the sample prototype and the actual sampling embedding obtained through the basic learner coding.

Then specifically, to enable the meta-learning strategy with the unknown model to concentrate on the hyper-parameter in the basic learner of the causal identifier and quickly adapt to the multilingual causality identification task, the bias parameter and the weight coefficient of the linear layer can be approximately calculated according to the sample prototype, instead of being randomly initialized, thus greatly improving the training efficiency. Approximate calculation refers to the use of an efficient way to estimate these parameters and weights, rather than performing a lot of iterative updates by the traditional gradient descent and other methods. Completing the approximate calculation of the bias parameter and the weight coefficient of the linear layer can avoid the backpropagation and optimization of the required expressive second-order calculation.

Finally, the causality identification process to the basic input sample by the causality identification unit of the causal identifier can be denoted as:

$$P ( y \vert {\tilde{d}}^{l} , {\tilde{S}}_{l} ) = softmax ( {b}_{l} + {W}_{l} {f}_{Θ} ( {\tilde{d}}^{l} ) )$$

In the formula, bₗ represents a bias parameter of the linear layer, and Wₗ represents a weight coefficient of the linear layer.

The approximate calculation for the parameter and parameter weight of the linear layer has the following calculation formula:

$${W}_{l} := 2 {ρ}_{y}^{l}$$

$${b}_{l} := - {ρ}_{y}^{{l}^{T}} {ρ}_{y}^{l}$$

In the formula, η_{y}^{l} represents a sample prototype of the y-th type.

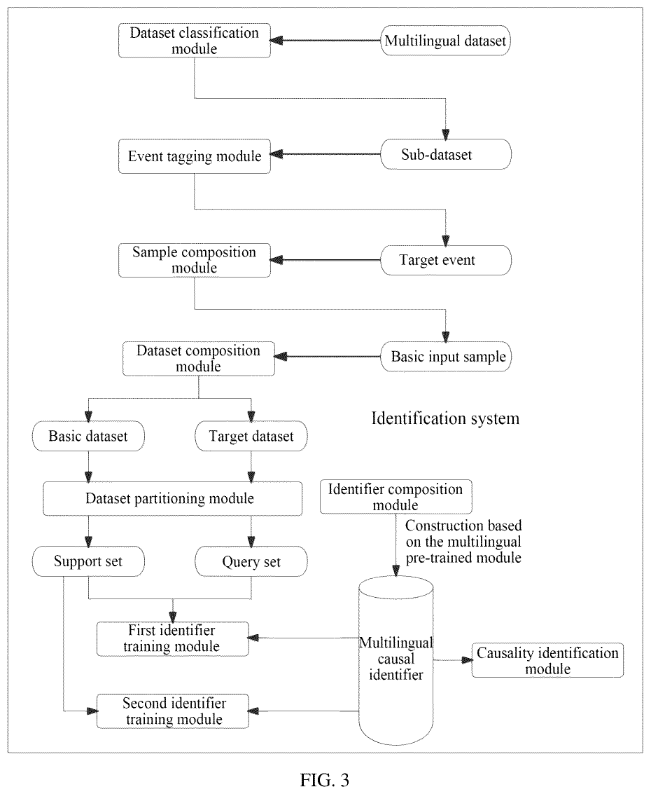

As shown in FIG. 3, the present disclosure further provides a multilingual event causality identification system based on meta-learning with knowledge, including:
a dataset classification module, configured to partition a to-be-processed multilingual dataset into a plurality of sub-datasets according to language types;
an event tagging module, configured to tag target events corresponding to all data samples in the plurality of sub-datasets;
a sample composition module, configured to obtain background knowledge for the various target events of different language types by using a preset semantic network and a knowledge reasoning framework, and to combine the background knowledge with a corresponding data sample to obtain a basic input sample;
a dataset composition module, configured to enable the basic input samples of all non-target languages in the basic input sample to constitute a plurality of basic datasets according to the language types, and to enable all the remaining basic input samples to constitute a target dataset;
a dataset partitioning module, configured to partition both the target dataset and the plurality of basic datasets into support sets and query sets;
an identifier composition module, configured to construct a multilingual causal identifier based on a multilingual pre-trained model;
a first identifier training module, configured to train the multilingual causal identifier based on the support sets and query sets in the plurality of basic datasets and using a prototype network and a hybrid meta-learning strategy with an unknown model, to obtain an optimal hyper-parameter of the multilingual causal identifier;
a second identifier training module, configured to train the multilingual causal identifier by using the support set in the target dataset, to obtain an optimal non-hyper-parameter of the multilingual causal identifier; and
a causality identification module, configured to identify the causality between events corresponding to all samples in the query set of the target dataset through the multilingual causal identifier.

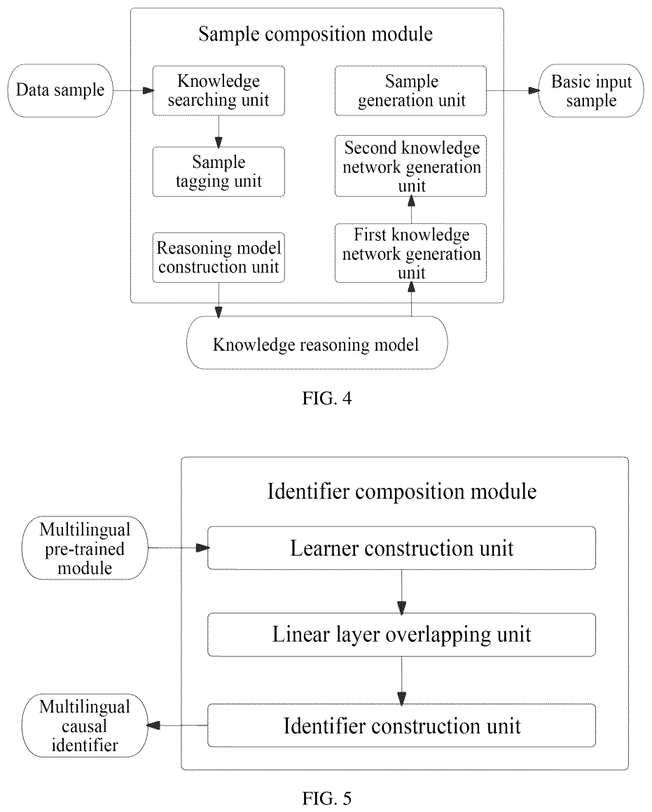

As shown in FIG. 4, in one implementation mode, the sample composition module includes:
a knowledge searching unit, configured to traverse all data samples, to search by using the preset semantic network to obtain target background knowledge of the target events corresponding to the data samples;
a sample tagging unit, configured to denote the data samples that do not obtain the target background knowledge by searching the semantic network as special data samples;
a reasoning model construction unit, configured to construct a knowledge reasoning model based on the preset knowledge reasoning framework and combined with a language translator;
a first knowledge network generation unit, configured to input the special data samples to the knowledge reasoning model, to obtain an initial knowledge network;
a second knowledge network generation unit, configured to generate a target knowledge network by combining the initial knowledge network with the target background knowledge; and
a sample generation unit, configured to textualize the target knowledge network and combine the target knowledge network with the data samples, to obtain the basic input samples.

As shown in FIG. 5, in one implementation mode, the identifier composition module includes:
a learner construction unit, configured to construct a basic learner based on the multilingual pre-trained model, where the basic learner includes an initial hyper-parameter that needs to be learned;
a linear layer overlapping unit, configured to overlay a linear layer on the basic learner, where the linear layer includes a bias parameter and a weight coefficient;
an identifier construction unit, configured to nest the basic learner overlapped with the linear layer into a nonlinear activation layer, to constitute the multilingual causal identifier.

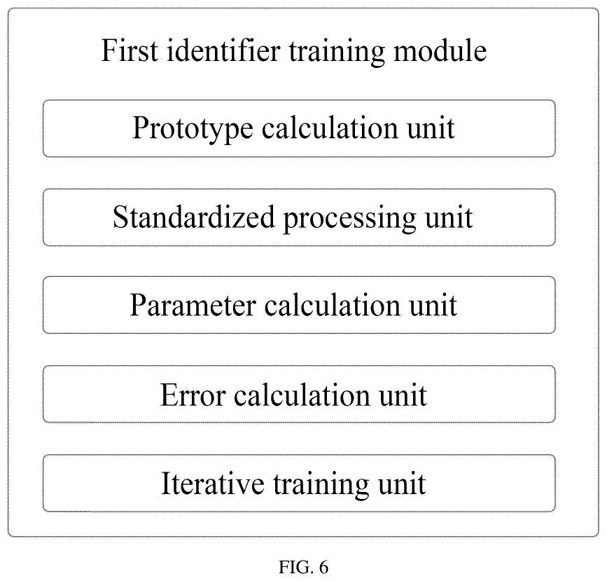

As shown in FIG. 6, in one implementation mode, the first identifier training module includes:
a prototype calculation unit, configured to code all target basic input samples in the support sets of the basic datasets by using the basic learner, and to obtain a sample prototype of each target basic input sample by calculating an average value of template coding with the corresponding type of the target basic input samples;
a standardized processing unit, configured to perform normalization processing on all sample prototypes based on a L2 standardization strategy;
a parameter calculation unit, configured to define the bias parameter and weight coefficient according to the sample prototypes, to complete an approximate calculation for the bias parameter and weight coefficient;
an error calculation unit, configured to perform a causal prediction on the query set in the basic dataset through the multilingual causal identifier, and to calculate and obtain a causal prediction error according to a prediction result of the causal prediction;
an iterative training unit, configured to perform iterative training on the multilingual causal identifier based on the meta-learning strategy with an unknown model with a target of minimizing the causal prediction error, and to obtain the optimal hyper-parameter of the multilingual causal identifier.

In one implementation mode, the optimal hyper-parameter has an expression formula as follows:

$${Θ}^{*} := \begin{matrix}arg max \\ Θ\end{matrix} {𝔼}_{k ⊂ K} [ {𝔼}_{{\tilde{S}}_{l} ⊂ {\tilde{D}}_{l} , {\tilde{Q}}_{l} ⊂ {\tilde{D}}_{l}} [ {\sum }_{( {\tilde{d}}^{l} , y ) ∈ {\tilde{Q}}_{l}} {P}_{Θ} ( y \vert {\tilde{d}}^{l} , {\tilde{S}}_{l} ) ] ]$$

in the formula, Θ represents an initial hyper-parameter, Θ* represents an optimal hyper-parameter, :=represents a defined symbol, K represents total rounds in the iterative training, k represents the k-th optimal iterative process in the iterative training, [symbol] _{k⊂K} represents an expectation for the k-th optimal iterative process, [symbol] _{\tilde{S}S}_{ₗ}_{⊂\tilde{D}}_{ₗ}_{,\tilde{Q}}_{ₗ}_{⊂\tilde{D}}_{ₗ} represents an expectation under the training of the support set and query set in the basic dataset, \tilde{D}ₗ={\tilde{S}ₗ, \tilde{Q}ₗ}, \tilde{D}ₗ represent a basic dataset, \tilde{S}ₗ represents a support set of the basic dataset, \tilde{Q}ₗ represents a query set of the basic dataset, \tilde{d}^{l} represents a basic input sample, y represents a tag corresponding to the basic input sample, and P_{Θ}(y|\tilde{d}^{l}, \tilde{S}ₗ) represents a conditional probability.

Those of ordinary skill in the art should understand: that the discussion of any embodiment above is only exemplary, not intended to imply that the scope of protection of this application is limited to these examples; under the concept of this application, the above embodiments or technical features in different embodiments can also be combined, the steps can be implemented in any order, many other changes above for different methods in one or more embodiments of this application exist, and these changes are not provided in detain for concision.

One or more embodiments of this application aim at covering all these replacements, modifications, and deformations in a wide scope of this application. Therefore, any omissions, modifications, equivalent replacements, improvements, and the like made within the spirit and principle of one or more embodiments of this application shall fall within the scope of protection of this application.

What is claimed is:

1. A multilingual event causality identification method based on meta-learning with knowledge, comprising the following steps:
partitioning a to-be-processed multilingual dataset into a plurality of sub-datasets according to language types;
tagging target events corresponding to all data samples in the plurality of sub-datasets;
obtaining background knowledge for the various target events of different language types by using a preset semantic network and a knowledge reasoning framework, and combining the background knowledge with a corresponding data sample to obtain a basic input sample;
basic input samples of all non-target languages in the basic input sample constituting a plurality of basic datasets according to the language types, and all the remaining basic input samples constituting a target dataset;
partitioning both the target dataset and the plurality of basic datasets into support sets and query sets;
constructing a multilingual causal identifier based on a multilingual pre-trained model;
training the multilingual causal identifier based on the support sets and query sets in the plurality of basic datasets and using a prototype network and a hybrid meta-learning strategy with an unknown model, to obtain an optimal hyper-parameter of the multilingual causal identifier;
training the multilingual causal identifier by using the support set in the target dataset, to obtain an optimal non-hyper-parameter of the multilingual causal identifier; and
identifying the causality between events corresponding to all samples in the query set of the target dataset through the multilingual causal identifier.

2. The multilingual event causality identification method based on meta-learning with knowledge according to claim 1, wherein the obtaining the background knowledge for the various target events of different language types by using the preset semantic network and the knowledge reasoning framework, and combining the background knowledge with the corresponding data sample to obtain the basic input sample comprises the following steps:
traversing all data samples, searching by using the preset semantic network to obtain target background knowledge of the target events corresponding to the data samples;
denoting the data samples that do not obtain the target background knowledge by searching the semantic network as special data samples;
constructing a knowledge reasoning model based on the preset knowledge reasoning framework and combining with a language translator;
inputting the special data samples to the knowledge reasoning model, to obtain an initial knowledge network;
generating a target knowledge network by combining the initial knowledge network with the target background knowledge; and
textualizing the target knowledge network and combining the target knowledge network with the data samples, to obtain the basic input samples.

3. The multilingual event causality identification method based on meta-learning with knowledge according to claim 1, wherein the constructing the multilingual causal identifier based on the multilingual pre-trained model comprises the following steps:
constructing a basic learner based on the multilingual pre-trained model, and the basic learner comprising an initial hyper-parameter that needs to be learned;
overlaying a linear layer on the basic learner, and the linear layer comprising a bias parameter and a weight coefficient; and
nesting the basic learner overlapped with the linear layer into a nonlinear activation layer, to constitute the multilingual causal identifier.

4. The multilingual event causality identification method based on meta-learning with knowledge according to claim 3, wherein the training of the multilingual causal identifier based on the support sets and query sets in the plurality of basic datasets and using the prototype network and the hybrid meta-learning strategy with the unknown model, to obtain the optimal hyper-parameter of the multilingual causal identifier comprises the following steps:
coding all target basic input samples in the support sets of the basic datasets by using the basic learner, and obtaining a sample prototype of each target basic input sample by calculating an average value of template coding with the corresponding type of the target basic input samples;
performing normalization processing on all sample prototypes based on an L2 standardization strategy;
defining the bias parameter and weight coefficient according to the sample prototypes, to complete an approximate calculation for the bias parameter and weight coefficient;
performing a causal prediction on the query set in the basic dataset through the multilingual causal identifier, and calculating and obtaining a causal prediction error according to a prediction result of the causal prediction; and
performing iterative training on the multilingual causal identifier based on the meta-learning strategy with unknown model with a target of minimizing the causal prediction error, and obtaining the optimal hyper-parameter of the multilingual causal identifier.

5. The multilingual event causality identification method based on meta-learning with knowledge according to claim 4, wherein the optimal hyper-parameter has an expression formula as follows:
$${Θ}^{*} := \begin{matrix}arg max \\ Θ\end{matrix} {𝔼}_{k ⊂ K} [ {𝔼}_{{\tilde{S}}_{l} ⊂ {\tilde{D}}_{l} , {\tilde{Q}}_{l} ⊂ {\tilde{D}}_{l}} [ {\sum }_{( {\tilde{d}}^{l} , y ) ∈ {\tilde{Q}}_{l}} {P}_{Θ} ( y \vert {\tilde{d}}^{l} , {\tilde{S}}_{l} ) ] ]$$
in the formula, Θ represents an initial hyper-parameter, Θ* represents an optimal hyper-parameter, :=represents a defined symbol, K represents total rounds in the iterative training, k represents the k-th optimal iterative process in the iterative training, [symbol] _{k⊂K} represents an expectation for the k-th optimal iterative process, [symbol] _{\tilde{S}S}_{ₗ}_{⊂\tilde{D}}_{ₗ}_{,\tilde{Q}}_{ₗ}_{⊂\tilde{D}}_{ₗ} represents an expectation under the training of the support set and query set in the basic dataset, i={\tilde{S}ₗ, \tilde{Q}ₗ}, \tilde{D}ₗ represent a basic dataset, \tilde{S}ₗ represents a support set of the basic dataset, \tilde{Q}ₗ represents a query set of the basic dataset, \tilde{d}ₗ represents a basic input sample, y represents a tag corresponding to the basic input sample, and P_{Θ}(y|\tilde{d}^{l}, \tilde{S}ₗ) represents a conditional probability.

6. A multilingual event causality identification system based on meta-learning with knowledge, comprising:
a dataset classification module, configured to partition a to-be-processed multilingual dataset into a plurality of sub-datasets according to language types;
an event tagging module, configured to tag target events corresponding to all data samples in the plurality of sub-datasets;
a sample composition module, configured to obtain background knowledge for the various target events of different language types by using a preset semantic network and a knowledge reasoning framework, and to combine the background knowledge with a corresponding data sample to obtain a basic input sample;
a dataset composition module, configured to enable the basic input samples of all non-target languages in the basic input sample to constitute a plurality of basic datasets according to the language types, and to enable all the remaining basic input samples to constitute a target dataset;
a dataset partitioning module, configured to partition both the target dataset and the plurality of basic datasets into support sets and query sets;
an identifier composition module, configured to construct a multilingual causal identifier based on a multilingual pre-trained model;
a first identifier training module, configured to train the multilingual causal identifier based on the support sets and query sets in the plurality of basic datasets and using a prototype network and a hybrid meta-learning strategy with an unknown model, to obtain an optimal hyper-parameter of the multilingual causal identifier;
a second identifier training module, configured to train the multilingual causal identifier by using the support set in the target dataset, to obtain an optimal non-hyper-parameter of the multilingual causal identifier; and
a causality identification module, configured to identify the causality between events corresponding to all samples in the query set of the target dataset through the multilingual causal identifier.

7. The multilingual event causality identification system based on meta-learning with knowledge according to claim 6, wherein the sample composition module comprises:
a knowledge searching unit, configured to traverse all data samples, to search by using the preset semantic network to obtain target background knowledge of the target events corresponding to the data samples;
a sample tagging unit, configured to denote the data samples that do not obtain the target background knowledge by searching the semantic network as special data samples;
a reasoning model construction unit, configured to construct a knowledge reasoning model based on the preset knowledge reasoning framework and combined with a language translator;
a first knowledge network generation unit, configured to input the special data samples to the knowledge reasoning model, to obtain an initial knowledge network;
a second knowledge network generation unit, configured to generate a target knowledge network by combining the initial knowledge network with the target background knowledge; and
a sample generation unit, configured to textualize the target knowledge network and combine the target knowledge network with the data samples, to obtain the basic input samples.

8. The multilingual event causality identification system based on meta-learning with knowledge according to claim 6, wherein the identifier composition module comprises:
a learner construction unit, configured to construct a basic learner based on the multilingual pre-trained model, wherein the basic learner comprises an initial hyper-parameter that needs to be learned;
a linear layer overlapping unit, configured to overlay a linear layer on the basic learner, wherein the linear layer comprises a bias parameter and a weight coefficient; and
an identifier construction unit, configured to nest the basic learner overlapped with the linear layer into a nonlinear activation layer, to constitute the multilingual causal identifier.

9. The multilingual event causality identification system based on meta-learning with knowledge according to claim 8, wherein the first identifier training module comprises:
a prototype calculation unit, configured to code all target basic input samples in the support sets of the basic datasets by using the basic learner, and to obtain a sample prototype of each target basic input sample by calculating an average value of template coding with the corresponding type of the target basic input samples;
a standardized processing unit, configured to perform normalization processing on all sample prototypes based on an L2 standardization strategy;
a parameter calculation unit, configured to define the bias parameter and weight coefficient according to the sample prototypes, to complete an approximate calculation for the bias parameter and weight coefficient;
an error calculation unit, configured to perform a causal prediction on the query set in the basic dataset through the multilingual causal identifier, and to calculate and obtain a causal prediction error according to a prediction result of the causal prediction; and
an iterative training unit, configured to perform iterative training on the multilingual causal identifier based on an unknown-model meta-learning strategy with a target of minimizing the causal prediction error, and obtaining the optimal hyper-parameter of the multilingual causal identifier.

10. The multilingual event causality identification system based on meta-learning with knowledge according to claim 9, wherein the optimal hyper-parameter has an expression formula as follows:
$${Θ}^{*} := \begin{matrix}arg max \\ Θ\end{matrix} {𝔼}_{k ⊂ K} [ {𝔼}_{{\tilde{S}}_{l} ⊂ {\tilde{D}}_{l} , {\tilde{Q}}_{l} ⊂ {\tilde{D}}_{l}} [ {\sum }_{( {\tilde{d}}^{l} , y ) ∈ {\tilde{Q}}_{l}} {P}_{Θ} ( y \vert {\tilde{d}}^{l} , {\tilde{S}}_{l} ) ] ]$$
in the formula, Θ represents an initial hyper-parameter, Θ* represents an optimal hyper-parameter, :=represents a defined symbol, K represents total rounds in the iterative training, k represents the k-th optimal iterative process in the iterative training, [symbol] _{k⊂K} represents an expectation for the k-th optimal iterative process, [symbol] _{\tilde{S}S}_{ₗ}_{⊂\tilde{D}}_{ₗ}_{,\tilde{Q}}_{ₗ}_{⊂\tilde{D}}_{ₗ} represents an expectation under the training of the support set and query set in the basic dataset, \tilde{D}ₗ={\tilde{S}ₗ, \tilde{Q}ₗ}, \tilde{D}ₗ represent a basic dataset, \tilde{S}ₗ represents a support set of the basic dataset, \tilde{Q}ₗ represents a query set of the basic dataset, \tilde{d}^{l} represents a basic input sample, y represents a tag corresponding to the basic input sample, and P_{Θ}(y|\tilde{d}^{l}, \tilde{S}ₗ) represents a conditional probability.
